(19) United States
(12) Patent Application Publication
(10) Pub. No.: US 2008/0278934 A1
(43) Pub. Date: Nov. 13, 2008

(54) LIGHTING SYSTEM

(75) Inventor: David Maldonado, Chula Vista, CA (US)

Correspondence Address: LAW OFFICE OF MARK WISNOSKY, 3060 6TH AVE., # 8, SAN DIEGO, CA, 92103, US

(73) Assignee: David Maldonado, Chula Vista, CA (US)

(21) Appl. No.: 11/745,606

(22) Filed: May 8, 2007

(51) Int. Cl. F21S 9/03

(52) U.S. Cl. 362/183

(57) ABSTRACT

A lighting system hardware and control are described. Advantages of the system include the ability to add lighting to an otherwise unmodified location by providing a clamping system that is adaptable to multiple configurations and remote operability. Remote operability includes the ability to use renewable power sources such as solar or wind power and the ability for self-calibration with respect to the time of day. The system also minimizes the number of circuit components required thus making it optimally inexpensive and reliable.

### TECHNICAL FIELD

Embodiments of the invention relate to lighting systems that may be replaceably attached to signs and posts. The system is especially useful for real estate signs.

### BACKGROUND OF THE INVENTION

The traditional means for advertising that a house is for sale or lease is by the placement of real estate signs at the front of the property. It is desirable that the signs are visible during high traffic times, which are often after sunset and before sunrise. The placement of the signs often precludes connection to conventional power sources such as outlets. A solar powered lighting system is a solution that has been suggested but still requires improvements for widespread acceptance. It is also desirable that the illumination can be turned off at specific hours. The ability to control the time that the illumination is on preserves battery life, is a courtesy to neighbors and may be required by local ordinance. Often the placement of the sign is not ideal for collection of solar energy. The ability to aim the solar photovoltaic collection panels independently of the light placement is an improvement. Non-ideal solar collection can also be mitigated by an improved power control system.

Doyle (U.S. Pat. No. 5,101,329) describes a lighting system for a real estate sign that clamps over the horizontal arm of the sign. Doyle provides no provisions for independently aiming the solar panels and no details for controlling the charging and discharging process. Tanner (U.S. Pat. No. 5,217,296) provides a lighting system to be attached to a flat wall and provides a means to independently aim the solar panels. However the control circuitry of Tanner is complicated and expensive. It requires separate circuitry for light sensing and battery and lamp control. Tanner does not provide means to control the lighting both before sunrise and after sunset. Tanner also does not provide for means to control the current or energy supplied to the lamps to prolong battery life. The mounting mechanism of Tanner would also not enable lockable attachment to a post. Giannone (U.S. Pat. No. 6,004,002) describes a complete real estate sign system including lighting. Although Giannone provides a solar panel that can be independently aimed, the system is not easily adapted to current signs without modification.

Typically the signs that are to be lighted are not located convenient to an electrical supply. Real Estate signs for example are often located at the front curb of the property far from convenient electrical outlets. There have been many systems advocating a battery powered system in which the batteries are recharged using electrical power from an associated photovoltaic solar panel. The challenge to implement such systems lies in designing a control system that will turn the lights on and off at the appropriate times, re-charge the batteries when solar energy is available, protect against over-charging the batteries to maintain battery life, protect against overheating batteries during the charging and discharging cycles, maximize utilization of the batteries available energy and prevent excessive discharge of the batteries such that the system is completely shutdown and control is lost and do all this with a minimum of electrical components to reduce cost. Schmidt (U.S. Pat. No. 6,028,694) describes an electronic control for LED's using a microcontroller and pulsed modulation for a power supply. However they do not describe an economical system. They include for example a switch mode power supply for current control. This task can more economically be accomplished with clever programming of the microcomputer.

There is a need for a portable solar lighting system that may be attached and securely locked to existing sign and post configurations without modification of the sign or post. There is a need to be able to lock the lighting system to the post using conventional padlocks to prevent theft. There is a need for a simplified control system for such lighting that will turn the lights on and off both after sunset and before sunrise, control the charge and discharge of the batteries in use and adjust the energy supplied to the lights to optimize battery life and illumination time. There is a need for a lighting system that can be flexibly aimed to light various portions of a sign attached to a post. A system is needed with the ability to aim the lighting to illuminate a top portion or attachment to a sign, a bottom portion or attachment to a sign and/or both. There is a need for a control system for a lighting system that will automatically determine the time of sunrise and sunset and program the duration of lighting of the sign relative to both sunset and sunrise.

### SUMMARY OF THE INVENTION

A lighting system for outdoor signage that fills the deficiencies of the current art is described. The system provides automatic control of the time when the lights are illuminated. These times can be set for durations both post sunset and pre sunrise. The same electronics that controls the turning on and off of the lights also provides for a control of the energy supplied to the lights as a function of the state of the battery charge and control the flow of energy from integrated photovoltaic solar panels to the batteries. The electronics prevent both overcharge and excessive discharge of the batteries. To insure a clear and complete description to enable a person of ordinary skill in the art to practice the invention, specific examples of applying the invention to a real estate and other commercial signs are provided. The associated hardware mechanism may be attached and locked to sign supports without the use of tools. It should be understood that the invention could apply to various modifications in other signage and non-signage illumination systems. The specific examples are not intended to limit the inventive concept to the example application. Other aspects and advantages of the invention will be apparent from the accompanying drawings and detailed description.

### BRIEF DESCRIPTION OF THE DRAWINGS

FIG. 1 is a view of a typical sign prior to attachment of the invention.

FIG. 2 represents one embodiment of the invention.

FIG. 3 is a second view of the embodiment presented in FIG. 2.

FIG. 4 presents an embodiment of the invention showing the lighting focus.

FIG. 5 represents a second and third embodiment of the invention.

FIG. 6 is a block diagram of the electronic circuitry of an embodiment of the invention.

FIG. 7 is a detailed block diagram of the circuitry of FIG. 6.

FIG. 8 is a schematic diagram of the circuitry of FIG. 7.

FIG. 9 is a block diagram of the control software of an embodiment of the invention.

FIG. 10 is a diagram showing the timing definitions of an embodiment of the invention.

FIG. 11 is a flow diagram of the light timer control software for an embodiment of the invention.

FIG. 12 is a flow chart of the time before sunrise tracking control of an embodiment of the invention.

FIG. 13 shows a typical discharge curve for a battery and the approximation to this curve used in an embodiment of the invention.

FIG. 14 is a diagram showing the duty cycle selection for an embodiment of the invention.

FIG. 15 is a diagram showing the definition of duty cycle as used in an embodiment of the invention.

FIG. 16 is a flow chart for the battery charger control software for an embodiment of the invention.

### DETAILED DESCRIPTION

The invention comprises three basic parts, a physical lighting fixture, electronics circuitry and algorithms used in conjunction with the control circuitry. A physical lighting fixture that may be removably attached to post or sign where lighting is required is described. The description shows embodiments for application to a real estate sign located remote from a source of power. Applicability to other lighting situation will become apparent through this detailed description. New circuitry to control the lighting is also described. The circuitry uses an economy of components yet still provides considerable flexibility in timing, charge and current control. The algorithms used to control the circuitry through the included microprocessor are also part of the described invention.

### Lighting Fixtures

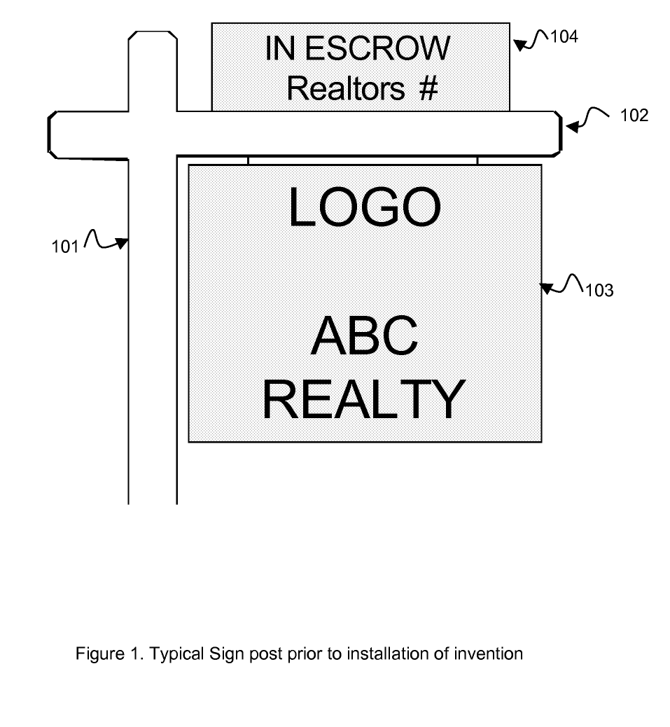

FIG. 1 shows a typical situation where the invention may be installed. A real estate sign consists of both a main sign portion 103 and a top sign portion 104 both of which would require periodic lighting. These signs are supported on a post structure comprised of a vertical upright post 101 and a cross beam 102. The invention may be attached and removed from this and similar structure without physical modification of the original sign structure.

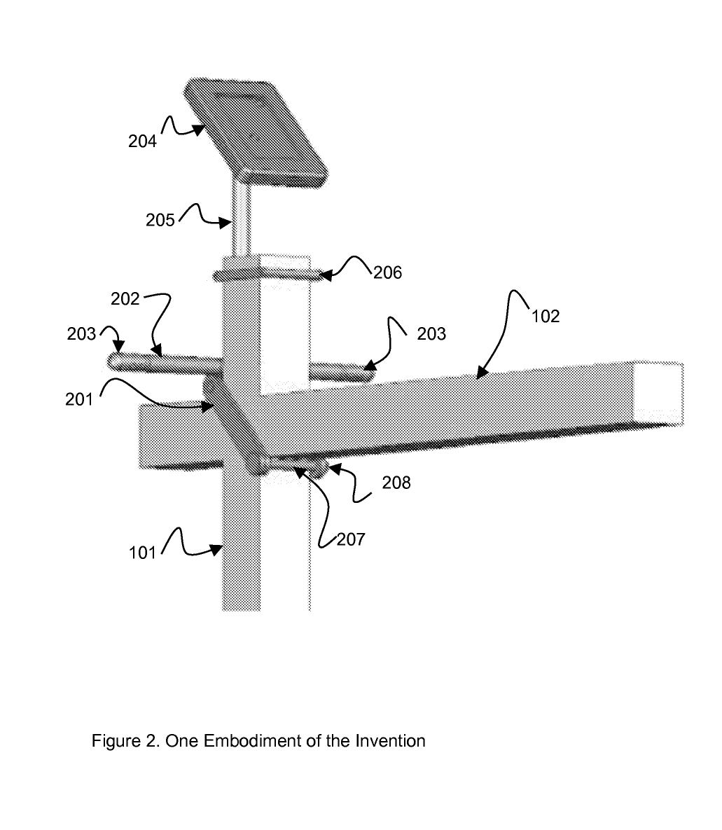

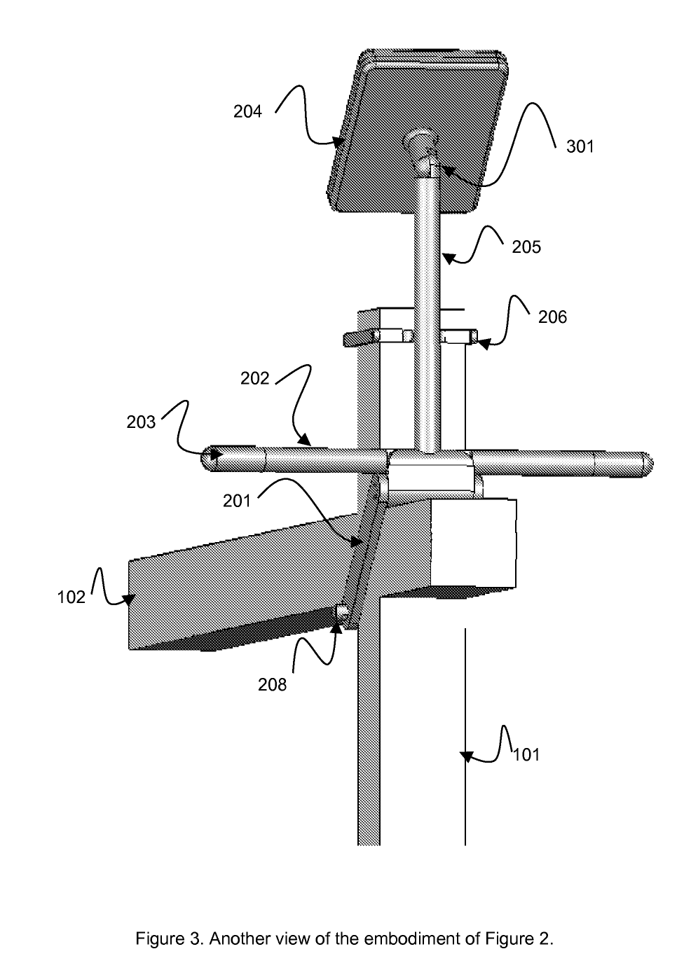

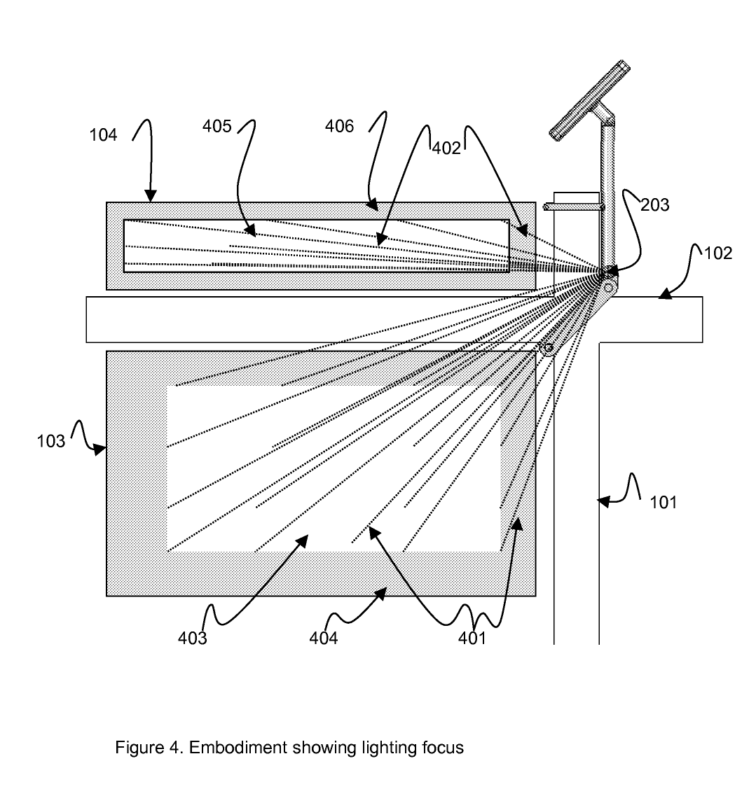

FIG. 2 shows one embodiment of the invention attached to a signpost of FIG. 1. A frame structure 201, 206, 207 and 208 is removably attached to the existing post. The Structure may be locked to the post for security purpose using a typical padlock attached through the hole 208 in the pin 207 attachment part. A light support means 202 is attached to the frame and serves to support and aim the lights 203 at the appropriate area of the sign. Another support means 205 supports a photovoltaic solar panel 204 in a position above the post and signage to avoid shadows. The frame structure 201, 206, 207, 208 and the light supports 202 and the solar panel 204 all fold flat for easy transport when the device is not attached to a post. FIG. 3, another view of the same embodiment, shows the attachment means 301 for the solar panel that enables both azimuth and elevation adjustment of the solar panel 204 to optimize solar collection for local physical location and geographical location. FIG. 4 depicts the focused lighting capability of an embodiment of the invention. The light sources 203 provide beams of light 401, 402 that can be aimed and focused on both the upper 104 and lower 103 signage sections. Areas of the sign may be highlighted by lighting an area of the sign 403, 405 that stand out by contrast from unlighted sections 404, 406 of the sign.

In another embodiment th entire sign is fully lit and the unlit areas 406 and 404 are eliminated.

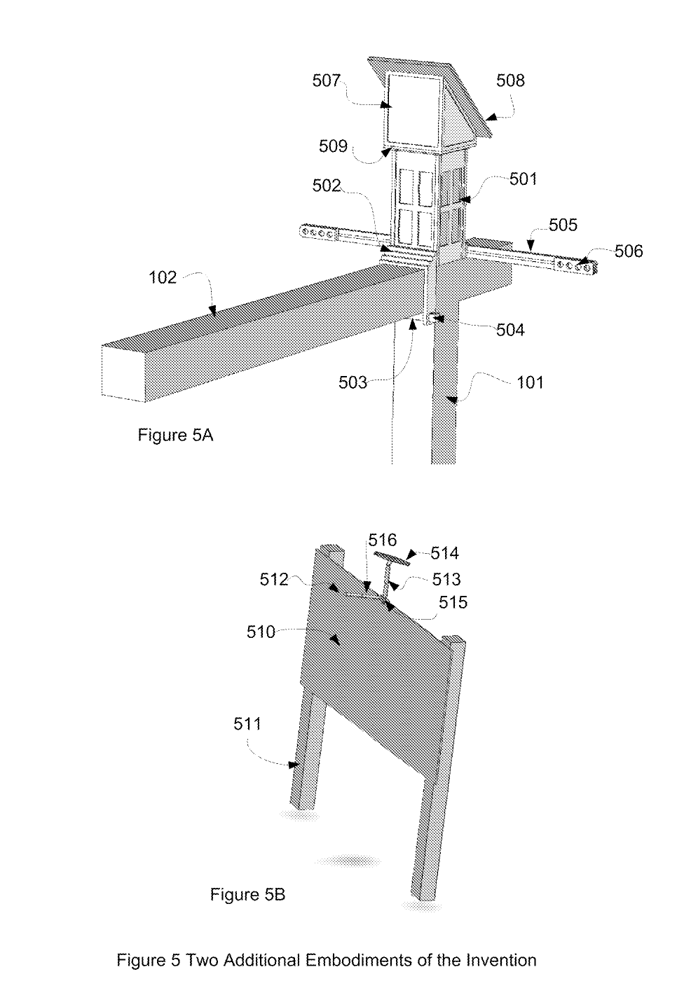

FIG. 5 depicts two additional embodiments of the invention. In FIG. 5a, a housing 501 fits over the top of the vertical post segment 101. The housing is clamped to the horizontal arm of the sign support through a clamping bracket 502 that is further comprised of a through pin 503 and a means 504 for attachment of a lock for security of the attachment. Lights 506 are attached to a light support arm 505. Photovoltaic solar panels 508 are attached to the top portion of the fixture through a combination housing and support 507. In the embodiment shown the elevation targeting of the solar panels is fixed by the angle of attachment to the housing and support 507. The angle and therefore the elevation may be designed for the particular latitude of the site where the system is used. Azimuth adjustment is provided by a rotatable mount 509 between the support 507 and the bottom housing 501. Batteries and electronics may be secured within the housing 507. In another embodiment the invention is applied to another sign that consists of support legs 511 and a one or two sided display panel 510. The lighting system is attached to the sign through a bolt system 515 that secures the fixture to the top of the sign. The light source 512 is embedded in a support arm 516. The solar panel 514 is attached to the top of a vertical support bar 513. Electronics are contained within any of the support arms 516 and 513 and within the solar panel housing.

### Electronic Circuitry

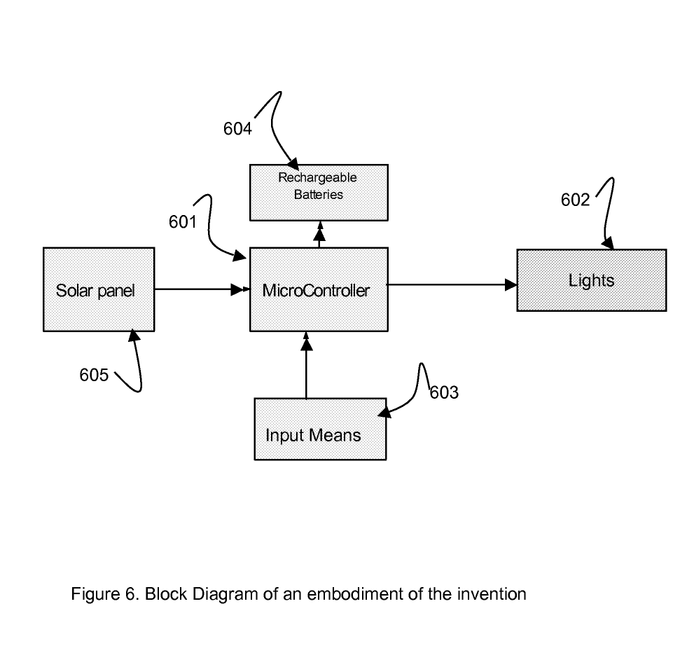

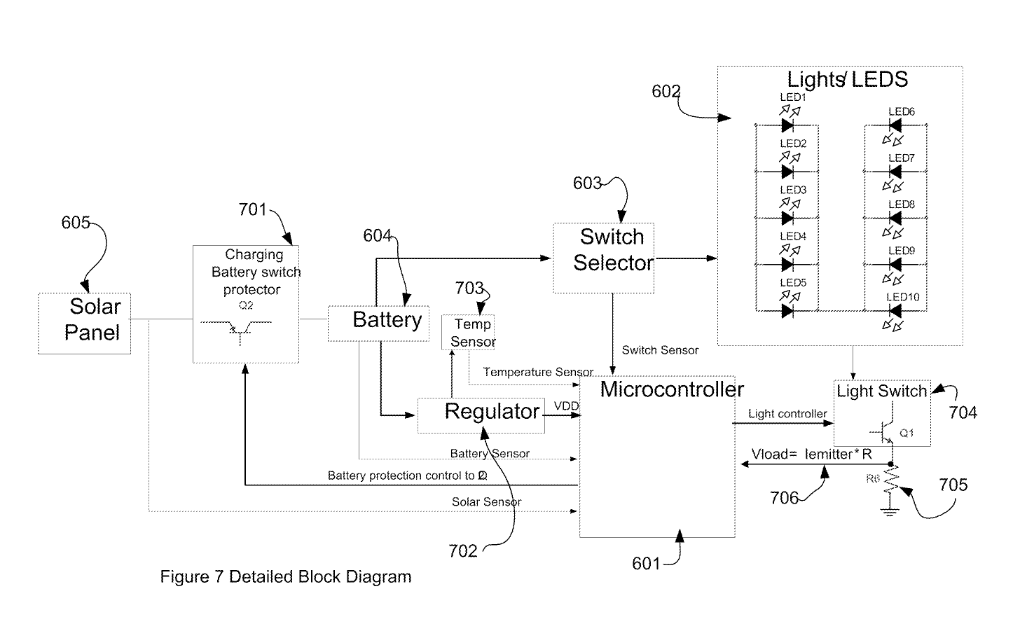

In one embodiment the circuit consists of 5 basic parts as depicted in FIG. 6. A microcontroller 601 is the focal point of connections to a photovoltaic solar panel 605 as source for recharging batteries 604 and therefore supplying energy to lights 602. An input means 603 allows the user to turn the system on and off and select lighting options. FIG. 7 depicts a more detailed block diagram of the circuits. A microcontroller 601, such as the PIC12F683 from Microchip, Inc. forms the heart of the system. The battery 604 provides regulated 702 power to the microcontroller. In another embodiment the regulator 702 also supplies regulated power to a temperature sensor 703 that is physically near the battery 604 to sense battery temperature and avoid overheating of the battery. Input to the microcontroller 601 is through integrated input ports and analog to digital converters. Inputs include voltage sense and measurement of the output of the photovoltaic solar panel 605, the output voltage of the battery 604, the output voltage of a temperature sensor and the settings of the input switch 603. Output from the microcontroller is through the GPIO ports and connect to the battery charging control transistor 701 and the light control transistor 704. In one embodiment the input means 603 is a simple selector switch that allows selection of lighting and other program options.

In another embodiment more accurate control of the energy supplied to the lights is provided by a control system that also includes a resistor 705 and line 706 connected to the microcontroller to read the voltage op over the resistor and thereby measure the current through the lights. The microprocessor can therefore control this current within preset limits. Real time current feedback is thus provided.

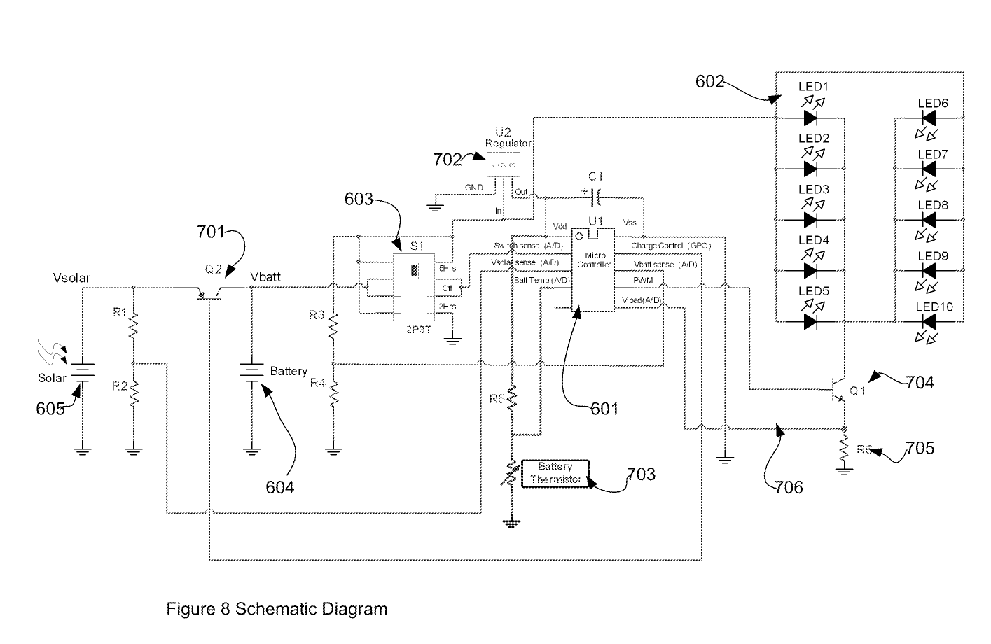

FIG. 8 depicts the detailed schematics of one embodiment of the invention. The main components for this apparatus are the Photovoltaic solar Panel 605, LEDs (Lights) 602, Battery 604, transistor switch to turn on/off the light (Q1) 704, the microcontroller 601, the on and off and user interface switch (S1) 603, the battery charging control transistor switch (Q2) 701 and in some embodiments a temperature sensing circuit (Battery thermistor) 703. Further elements, such as the regulator 702 are used to provide a reference voltage for the microcontroller and the thermistor. In another embodiment the regulator is internal to the microcontroller. In another embodiment the thermistor and switches such as Q1 and Q2 are internal to the microcontroller. The various resistors R1, R2, R3, R4, R5 are used as voltage divider to scale the voltage of the photovoltaic solar panels, battery or thermistor to fit the dynamic range of the analog to digital converters of the microcontroller. These inputs to the micro controller include Vsolar Sense (A/D), Switch sense (A/D), Vbatt sense (A/D) and Batt Temp (A/D)—the sensor for the battery temperature connected to the thermistor. The control lines that come out from the micro controller include: the Pulse Width Modulation (PWM) controller pin output which is used to turn ON and OFF the switch Q1 (transistor used as an electrical switch) that turns the lights on or off, the Charge control (GPO, general purpose output) which is used to control the switch (Q2) that transfers the current from the Solar panel to the battery during charging. The charging circuit charges the battery during the day via the PNP transistor Q2. The control circuit controls the charging time, the LED turn on time, and the time the LED's are on. The Dual pole 3 Trough switch (2P3T) provides an off, 3 Hr, and 5 Hr function that lets the consumer choose how long to turn the LED's on at night. The switch separates the charging circuit with the control circuit in the “Off” position of the switch. The regulator U2 provides a regulated output with variable input higher that output voltage. The transistor Q1 controls the current of the LED's via Pulse Width Modulation (PWM) at the base to produce a constant current for the LED's. The PIC microcontroller controls the entire circuit. It takes battery voltage measurements, photovoltaic solar cell voltage measurements, regulates the charging current and the LED current, and also determines the time to turn the LED's On at night.

In another embodiment the circuit additionally includes the resistor 705 and line 706 to provide current feedback control as discussed above. An advantage of the system is that only two transistors 701 and 704 are required for control of the lights, thus simplifying the system and reducing the cost compared with prior systems.

### Control Software

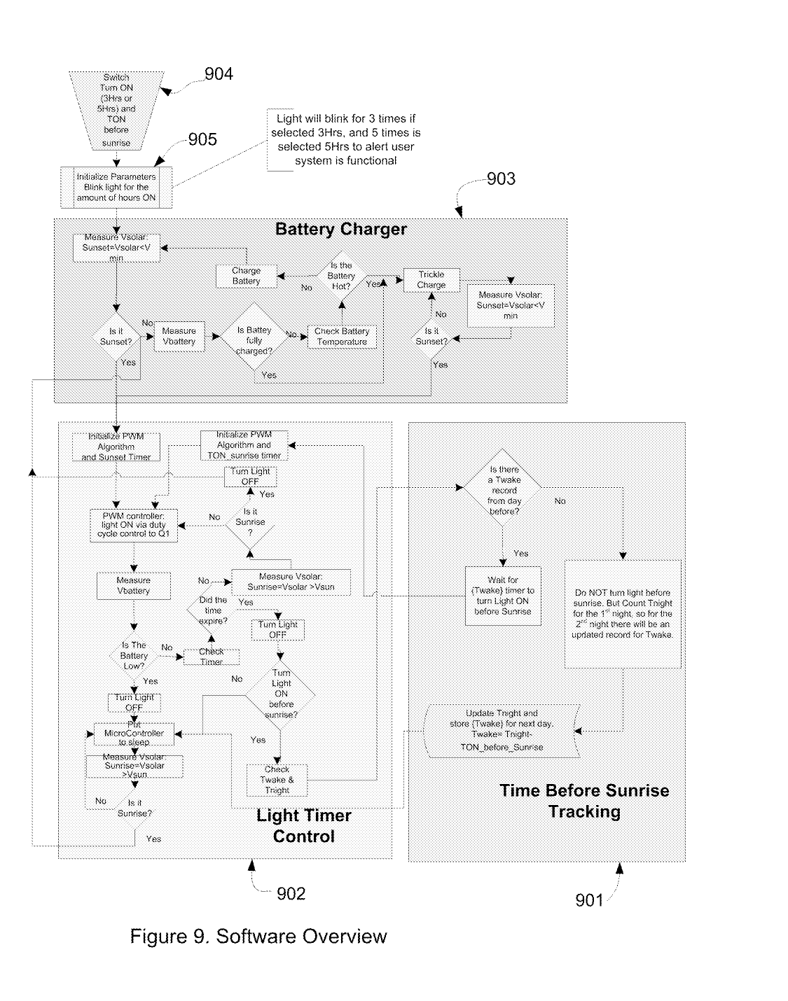

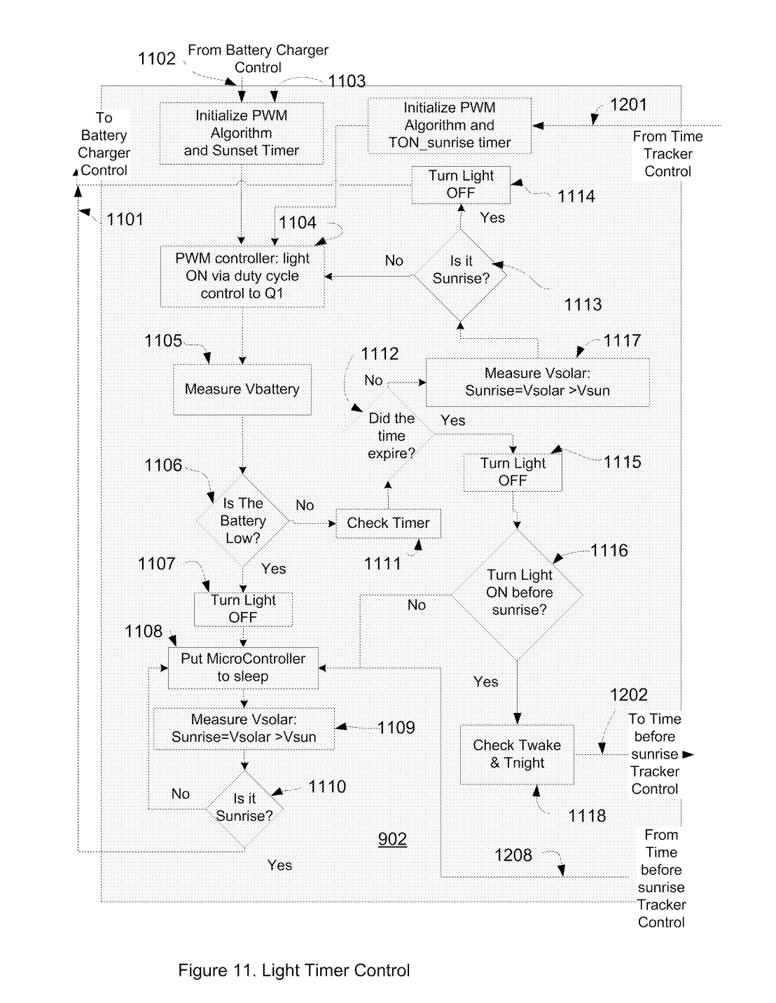

FIG. 9 depicts an overview of the software. The system is turned on and the desired program settings are selected 904. In one embodiment the program selection is through a multi-position switch that allows selection of hours after sunset the lights should be turned on and hours before sunrise that the lights should be turned on. At turn on the system is initialized 905. Initialization step includes feedback to the user of the program parameters and initialization of the battery charger algorithms 903. The three main components of the software system are the battery charge algorithms 903, the light timer control algorithm 902 and the time before sunrise tracker algorithm 901. Each are logically interlinked as shown in FIG. 9 and in the detailed views of FIGS. 11, 12 and 16 each of which are as discussed below.

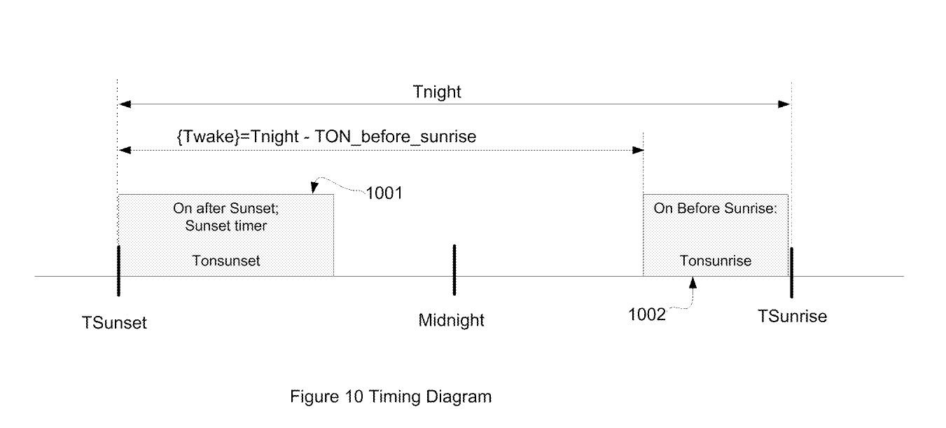

Time parameters are depicted in FIG. 10. Time parameters are either a measure of the time of day or a measure of duration. In one embodiment the system defines its own internal time of day clock by sensing sunrise and/or sunset or both based upon voltage measurements of the output of the solar panels. The time of sunset (Tsunset) is determined when the voltage of the solar panel falls below a trigger level. The time of the sunrise (Tsunrise) is determined when the voltage level of the solar panel exceeds a trigger level that would indicate the sun is impinging on the solar panels. The difference between Tsunset and Tsunrise is the length of the night Tnight. The duration of the lighting periods are Tonsunset 1001 and Tonsunrise 1002 which are the durations that the lights should be on after sunset and before sunrise respectively. Because of the programming and sensing capabilities there is no need to set or retain the actual time of day in the system memory. The system can self-calibrate. This allows for a simplified multi-position switch to be the user interface to program the system for durations of time the lights should be on after sunset and before sunrise.

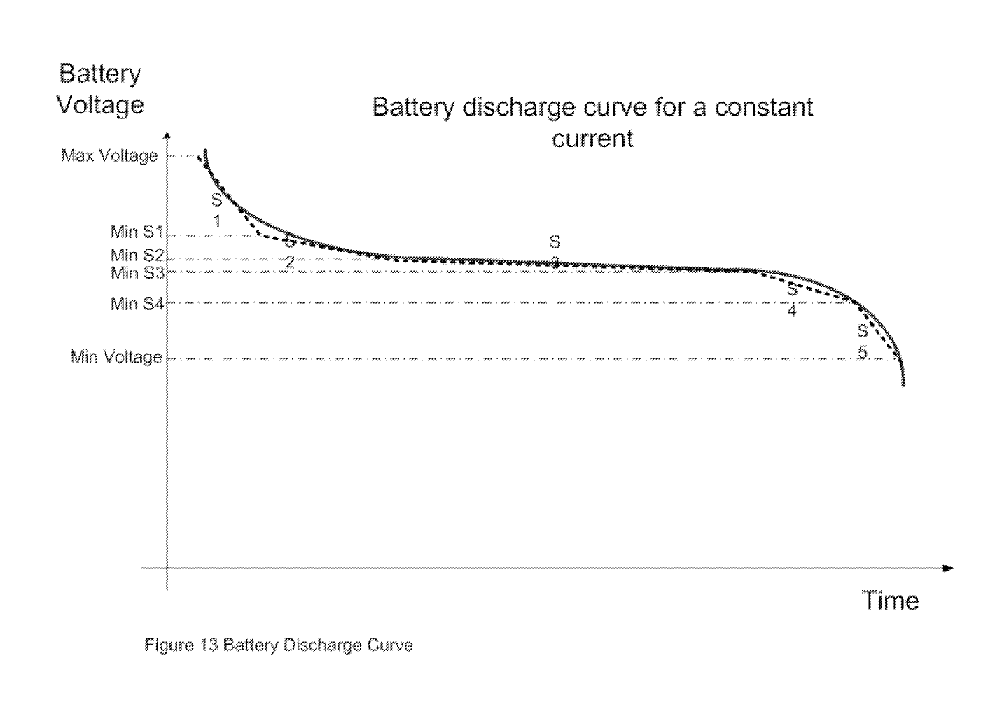

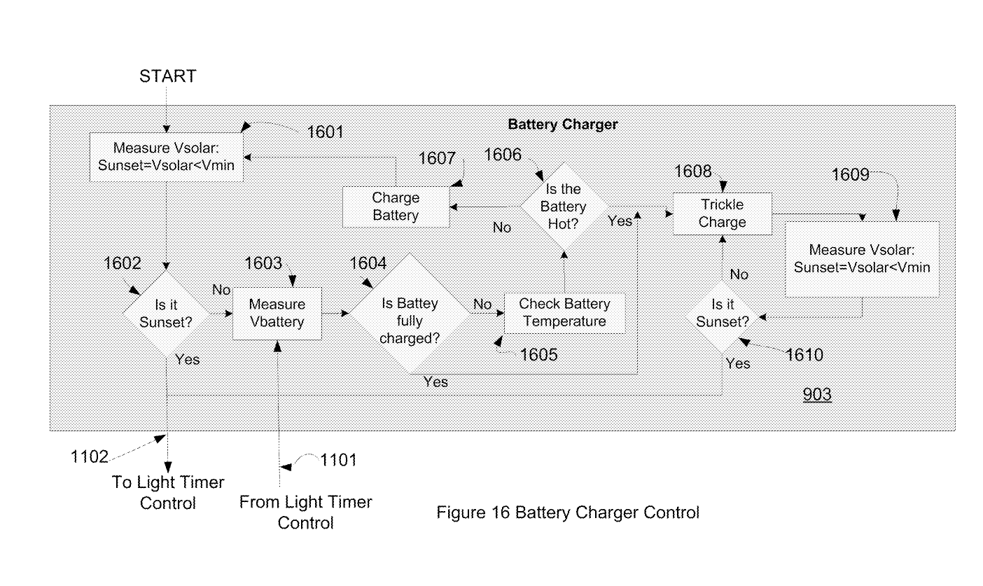

FIG. 11 depicts an exemplary embodiment of the light time control logic flow. Upon initial turn on of the system The battery charge logic, FIG. 16 discussed below, tests 1602 whether the sun has yet set or not based upon the voltage measurement from the solar panels. If it is past sunset a logic signal 1102 is sent to the light time control of FIG. 11 to control the lights. The initialization step 1103 sets the program parameters from the user interface settings in the logic memory. The pulse width modulation logic 1104 then sets the appropriate modulation parameters to control the lights. Parameters included in the modulation control are the timing parameters as well as measured voltage of the batteries and in some embodiments the voltage drop of the load thus providing current feedback control for the lights. The details of the pulse width modulation algorithm are discussed below in association with FIGS. 13, 14 and 15. The system then checks the batteries 1105 and determines whether the batteries are sufficiently charged to operate the lights 1106. If the battery levels are too low, the system will turn off the lights 1107 and put the microprocessor to sleep 1108 except for the monitoring of the solar panel voltages 1109 until the sun comes up. Once the system decides 1110 that the sun has risen, a logic signal 1101 is sent to the battery charger program to recharge the batteries. In this way the system protects the batteries from excess discharge. If it is determined 1106 the batteries have sufficient charge to operate the lights, the system will check the timer 1111 and determine 1112 whether the Tonsunset or Tonsunrise times have lapsed. If so the lights are turned off 1115 and the system checks 1116 whether there is a program parameter set to turn the lights on before sunrise. If so the system checks 1118 whether the system has been through a sunset and sunrise cycle such that it has self calibrated the time of day and can determine Twake and Tnight and turn the light on at the selected time. If the program does not call for the light to be turned on before sunrise (“no” path at 1116), the system will go into sleep mode 1108 and wait for sunrise as discussed above for a low battery situation.

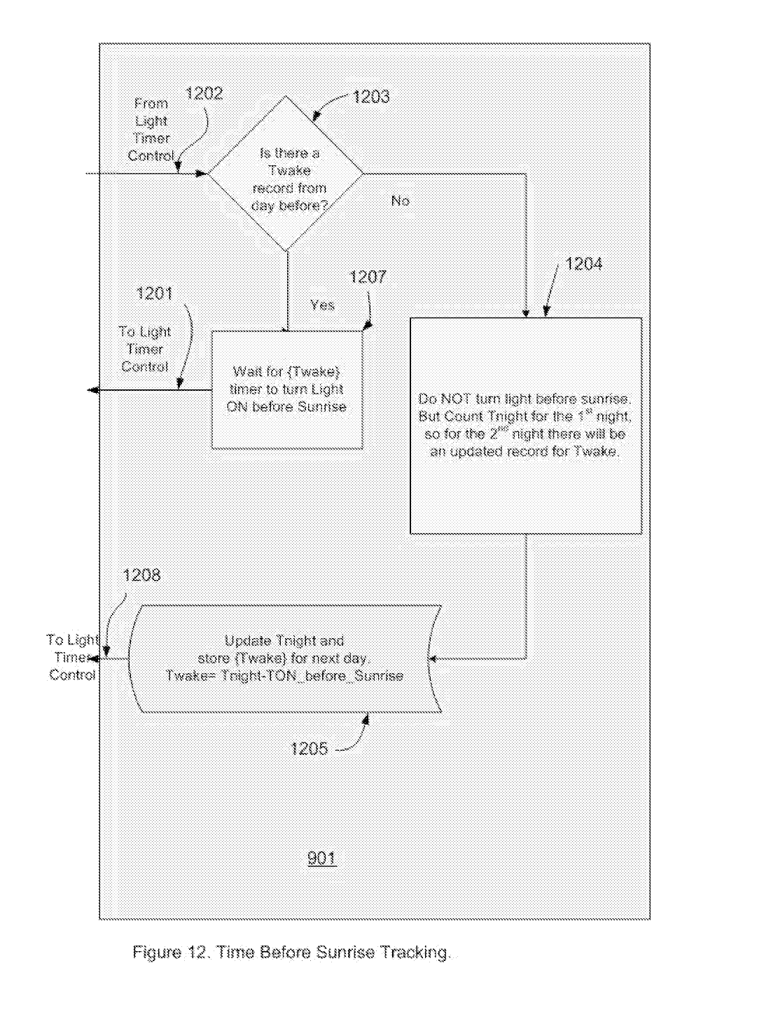

FIG. 12 depicts an embodiment where there is the ability to turn the lights on before sunrise. If the light timer control logic determines 1116 that there is a parameter set for lighting before sunrise a logic signal 1202 initializes the time before sunrise tracking control of FIG. 12. The system first checks 1203 whether a Twake time parameter has been determined from self calibration by the system having gone through a sunset/sunrise cycle. If not the system does not turn the lights on during the first pre-dawn operation 1204, but rather uses the first night cycle self calibrate and set the time of day parameters 1205. Once set 1205, control passes 1208 to the light timer control and the system is again put into sleep mode to wait for sunrise. If there is a Twake recorded from the day before 1203 the system will wait 1207 until the Twake time has lapsed and then initiate logic 1201 to turn the lights on before sunrise 1119.

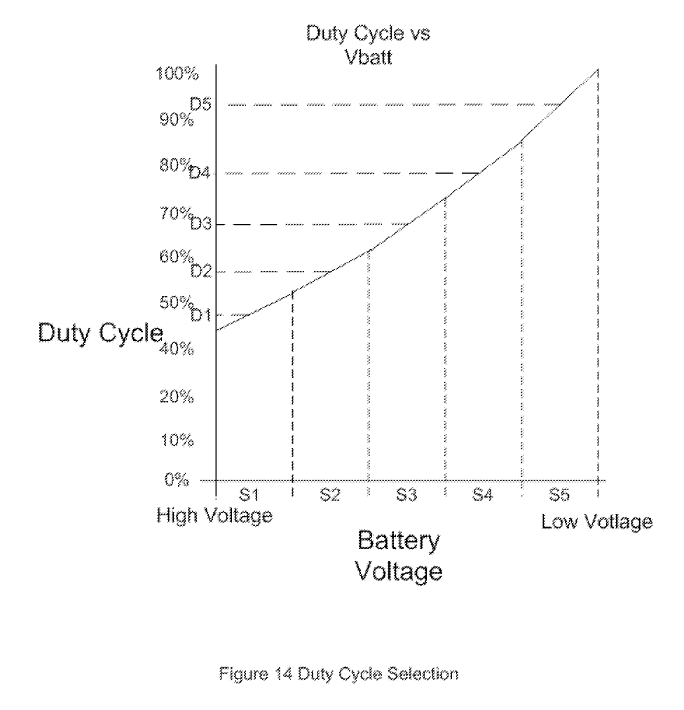

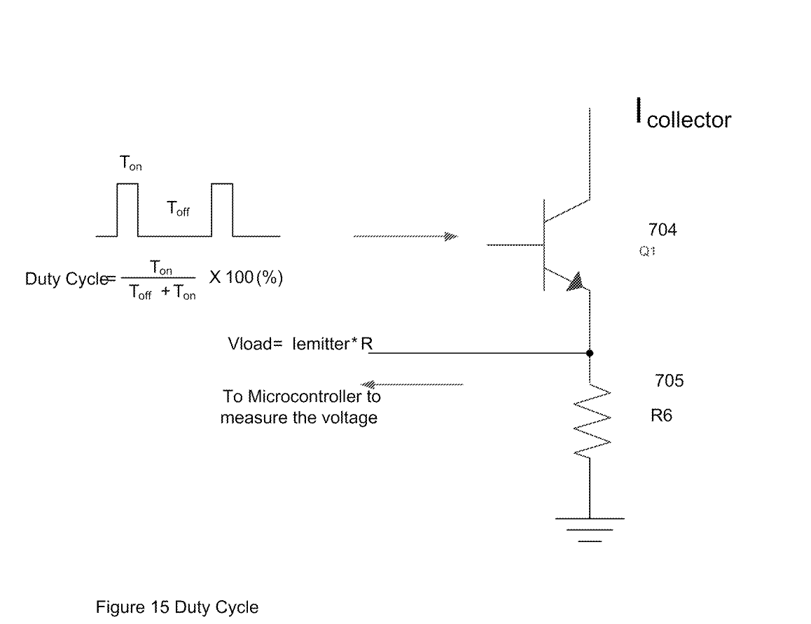

FIGS. 13, 14 and 15 depict the parameters associated with the pulse width modulation algorithm 1104. FIG. 13 shows a typical discharge curve for a battery used in an embodiment of the invention. Such curves are available from the manufacturers of the batteries. The PWM algorithm approximates the discharge curve by a series of linear segments Si. In the example of FIG. 13 there are 5 segments shown. The number of segments chosen is dependent upon the complexity of the discharge curve and the accuracy required for optimum operation of the lights and battery life. The minimum voltages of each linear segment, depicted as Min S1, Min S2, etc. allows the system to determine the current state of discharge of the battery by a measure the battery voltage. Once the current state of the battery is determined, a duty cycle Di, corresponding to Si, is selected from a chart such as depicted in FIG. 14. Although depicted as continuous curves one familiar with the art will realize the curves and selection of parameters Si and Di can be done through lookup tables encoded into the system memory. The system is therefore also seen to be independent of the type of batteries used. Each battery type would behave according to its own discharge curve, which may be encoded into the system to allow selection of the appropriate duty cycle Di as a function of the output voltage of the particular battery system. In another embodiment the battery type is selectable from a number of pre-stored discharge and duty cycle curves. FIG. 15 depicts an example of how the duty cycle is implemented in the system. The PWM modulation will operate on a cycle frequency characterized by the total of Ton and Toff. Ton, and therefore logically Toff, is calculated based upon the duty cycle, Di, selected for the current state of the battery. The microprocessor 601 is programmed to output pulses characterized by the calculated duty cycle. The peak voltage seen by the lights will be the voltage of the PWM output of the microprocessor, Vpwm of FIG. 15, multiplied by the gain of the transistor Q1 704. Therefore the lighting control can be customized for the particular lighting and microprocessor output voltage by selection of Q1 with a gain that will result in a voltage sufficient to operate the lights.

FIG. 16 depicts the logic for the battery charger control in an embodiment of the invention. Upon initiation the system first measures the solar panel voltage 1601 to determine whether the sun has set 1602. If not the system measure the battery voltage 1603 and determines 1604 whether the battery is fully charged based upon the discharge curves discussed above. If the battery is not fully charged, the system then checks the battery temperature 1605 and determines 1606 whether the battery is too hot to accept a full charge. If the battery is too hot, the system will trickle charge the battery 1608 while it waits for sunset 1609 and 1610. The system will also just trickle charge the battery 1608 if it determines 1604 that the battery is fully charged. If the battery is not fully charged and is not too hot to accept a full power charge, the system will allow full power to charge the battery through the logic of 1606 and 1607 while it awaits sunset 1601, 1602.

The described system uses the solar panel both for determination of the time of day and as a power source for the battery system. In another embodiment, not expressly shown, a second source of energy can be used to charge the battery 1607. Nonlimiting exemplary systems include wind power, hydroelectric power, gas or diesel powered generators or even a connection to a conventional electrical outlet when available.

In another embodiment the time of day is maintained through a battery system and the secondary source of power to recharge the batteries may be a wind generator, hydroelectric generator, gas or diesel powered generators or a connection to a conventional electrical outlet.

### CONCLUSIONS

Lighting system hardware and control are described. Advantages of the system include the ability to add lighting to an otherwise unmodified location by providing a clamping system that is adaptable to multiple configurations and remote operability. Remote operability includes the ability to use renewable power sources such as solar or wind power and the ability for self-calibration with respect to the time of day. The system also minimizes the number of circuit components required thus making it optimally inexpensive and reliable.

A number of embodiments of the invention have been described. It will be understood that various modifications may be made without departing from the spirit and scope of the invention.

I claim:

1. A lighting system comprising:
a) a light source which may be focused upon multiple targeted areas,
b) a clamp to removably and lockably attach the lighting system to a support,
c) a photovoltaic energy collector,
d) a rechargeable battery having a state of charge, and
e) a microprocessor controller that controls the lighting power through pulse width modulation and controls the time of day to turn the lights on and off and controls the charging of the battery.

2. The lighting system of claim 1 where the microprocessor controller is self-calibrating as to the time of day.

3. The illumination device of claim 1 where the pulse width modulation is varied based upon a measured voltage of the rechargeable battery and a discharge curve for the rechargeable battery.

4. The lighting system of claim 1 where the microprocessor controller comprises a microprocessor, two transistors and a voltage regulator.

5. The lighting system of claim 1 where the microprocessor controller includes a battery temperature sensor.

6. The lighting system of claim 1 where the microprocessor controller turns the lighting means on for a user selectable time before sunrise.

7. The lighting system of claim 1 where the light source is a plurality of light emitting diodes.

8. The lighting system of claim 1 where the support is a real estate sign post.

9. The lighting system of claim 1 where the photovoltaic energy collector may be rotated and tilted.

10. The lighting system of claim 1 where the tilt of the photovoltaic energy collector is selected on the basis of the geographical latitude of the lighting system location.

11. The lighting system of claim 1 where the microprocessor controller consists essentially of a microprocessor, two transistors and a voltage regulator.

12. An illumination device comprising:
a) at least one light emitting diode for producing light,
b) a microprocessor controlled power circuit for supplying a pulse modulated power signal to each light emitting diode at a user selectable time of day and a user selectable duration,
c) a rechargeable battery having a state of charge characterized by a discharge curve, and
d) a second power supply.

13. The illumination device of claim 12 where the second power supply is a photovoltaic panel.

14. The illumination device of claim 12 where the user selectable time of day includes pre-dawn hours.

15. The illumination device of claim 12 where the pulse modulated power signal is varied based upon a measured voltage of the rechargeable battery and the discharge curve for the rechargeable battery.

16. The illumination device of claim 12 where the second power supply is a wind generator.

17. A sign lighting fixture comprising:
a) a removable, foldable and lockable clamping means,
b) a light fixture extending horizontally from the clamping means to either side of the sign and capable of being aimed at specific areas of the sign,
c) a vertical housing having a top and a bottom wherein said bottom is attached to said clamping means,
d) a microprocessor controlled power supply contained within said housing,
e) at least one light emitting diode contained in said light fixture, and
f) a photovoltaic panel attached at the top of the vertical housing.

18. The sign lighting fixture of claim 17 wherein said microprocessor controlled power supply includes pulse width modulation of power to said at least one light emitting diode.

19. The sign lighting fixture of claim 17 wherein said microprocessor is self-calibrating as to time of day based upon voltage measurements of the output of said photovoltaic panel.

20. The sign lighting fixture of claim 17 wherein said microprocessor controlled power supply may be programmed to turn said at least one light emitting diode on before sunrise.
